(19) United States
(12) Patent Application Publication
(10) Pub. No.: US 2004/0143488 A1
(43) Pub. Date: Jul. 22, 2004

(54) System and method for integration of actual product costs

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/748,872

(22) Filed: Dec. 29, 2003

(30) Foreign Application Priority Data
Dec. 27, 2002 (TW) 91137608

(51) Int. Cl. G06F 17/60

(52) U.S. Cl. 705/10

(57) ABSTRACT

A system for integration of actual product costs (1) can calculate a product's actual costs by adding the product's value-added costs and the product's material costs. The system for integration of actual product costs is connected to a number of client terminals (3), a general ledger management system (4), a manufacturing process management system (5), a work order management system (6), a purchase management system (7), an inventory management system (8), and a production management system (9). The system for integration of actual product costs includes a web server (12), a database server (14), and a database (16). The web server includes a value-added costs integration module (121), a material costs integration module (122), an actual costs integration module (123), and an actual costs enquiry module (124). A related method is also provided.

### BACKGROUND OF THE INVENTION

1. Field of the Invention

The present invention relates to a system and method for cost accounting management, and especially to a computer-enabled system and method for integration of actual product costs.

2. Background of the Invention

During the 1970s and 1980s, many private enterprises were able to prosper while paying relatively little attention to cost management. This was particularly the case with smaller manufacturing companies that were not significantly affected by international competition. Since that time, consolidation and corporate takeovers have led to the emergence of numerous large-scale enterprises, whose commercial activities are correspondingly complex and increasingly subject to intense international competition. When certain of these companies have been able to increase revenue but without enjoying corresponding increases in profit, their competence in the area of cost management has been called into question. As one of the most important aspects of corporate management, effective cost management is closely related to cost analysis and profit distribution. Cost management is fundamental to the competence and development of virtually every company.

At present, there are many types of computer systems and management methods related to cost management. Most of these systems and methods focus on collecting cost data, and adopting a single type of or simplified apportionment standard such as direct labor work time, machine work time etc. in order to apportion costs to a production cost center and then to a product. For example, U.S. patent application Publication No. 2002/0069103 published on Jun. 6, 2002 provides “Methods and Systems Enabling the Identification of Actual Costs in a Transaction Based Financial and Manufacturing Environment.” The disclosed method and system collects actual cost data of at least one operation and actual cost data of at least one material from a business activity, gives each cost an identifier which corresponds to an operation or a material in the business activity, stores the actual cost data according to the identifiers, and then displays an output according to the actual cost data. However, this method can lead to underestimations or overestimations of product costs, which can result in undercharging or overcharging of customers. The resulting inconsistencies between product costs and revenues from customers can cause corporate management to make wrong decisions.

What is needed is a system and method of cost management which overcomes the above-described problems.

### SUMMARY OF THE INVENTION

Accordingly, a main objective of the present invention is to provide a system and method for integration of actual product costs which, on the basis of manufacturing expenses, work order data, purchase data, inventory data and consumed material data, calculates value-added product costs and product material costs.

Another objective of the present invention is to provide a system and method for integration of actual product costs by adding the value-added costs and material costs of a product.

To achieve the above objectives, a system for integration of actual product costs according to the present invention comprises a web server and a database server. The database server comprises a database for storing cost variable definition data, operation center definition data, manufacturing expenses data, purchase data, inventory data and consumed material data. The cost variable definition data comprise cost variance (hereinafter “variance”) related data including a cost variable code field, a cost variable name field, a cost variable unit field and other fields. The operation center definition data comprise data on cost variables and work centers of each of operation centers. The manufacturing expenses data comprise expenses of each of manufacturing expenses accounts. The purchase data comprise purchase date, material number, material name, purchase quantity, purchase unit price, purchase expenses. The inventory data comprise current period inventory data and initial inventory data. The consumed material data comprise product name, product number, current period produced quantity, and all consumed materials' numbers, names and quantities.

The web server comprises a value-added costs integration module, a material costs integration module, and an actual costs integration module. The value-added costs integration module is used for calculating value-added costs of a product. The value-added costs integration module comprises a cost group file creation sub-module for defining cost groups, manufacturing expenses accounts and cost variables in each cost group, and for calculating the manufacturing expenses of each cost group based on the manufacturing expenses data and the cost variable definition data; an operation center variance calculation sub-module for calculating the sum of all the operation centers' variances and each product's variance for each operation center, based on the operation center definition data and the work time data on work orders; a cost group apportionment sub-module for specifying a ratio of each cost group's manufacturing expenses apportioned to each operation center; and a value-added costs calculation sub-module for calculating each operation center's total costs, each cost group's manufacturing costs corresponding to the operation center, and the operation center's apportioned variance. The material costs integration module is used for calculating material costs of a product. The material costs integration module comprises a current period purchase costs calculation sub-module for calculating purchase expenses apportioned to each unit of a material and current period purchase costs of a unit of the material based on purchase data of the material; a historical purchase costs calculation sub-module for calculating historical purchase costs of a unit of the material based on the inventory data and the current period purchase costs; and a material costs calculation sub-module for calculating costs of each material consumed in a product and the material costs of the product based on the historical purchase costs of all the materials consumed in the product and produced quantity and each consumed material quantity of the product. The actual costs integration module is used for calculating actual costs of the product by summing up the value-added costs and the material costs of the product.

The present invention also provides a method for integration of actual costs for a product. The method includes the steps of: (a) calculating value-added costs of a product, comprising: (a1) defining cost variables, codes and other related data for generating cost variable definition data; (a2) defining work centers in each of operation centers and determining cost variables of each product in order to generate operation center definition data; (a3) obtaining manufacturing expenses information and saving the information as manufacturing expenses data; (a4) defining cost groups, and manufacturing expenses accounts and cost variables in each cost group based on the cost variable definition data and manufacturing expenses definition data, and calculating manufacturing expenses of each cost group; (a5) obtaining work time data on work orders, summing up all the work time on work orders of each work center in each operation center, and calculating an operation center total variance and product variances of each operation center; (a6) defining an apportioned variance to be apportioned to each operation center from the cost group's manufacturing expenses; and (a7) calculating the value-added costs of each product based on the manufacturing expenses of each cost group, the apportioned variance of each operation center, the operation center total variance of each operation center, and a product variance of that product; (b) calculating material costs of a product, comprising: (b1) obtaining purchase data and saving the data into the database; (b2) calculating current period purchase expenses apportioned to each unit material and current period costs of each unit material; (b3) obtaining inventory data and saving the data in the database; (b4) calculating historical purchase costs of each unit material; (b5) obtaining consumed material data of a product and saving the data in the database; (b6) calculating costs of each material consumed in the product; and (b7) summing up costs of all materials consumed in the product to obtain material costs of the product; and (c) adding the value-added costs and the material costs of a product to obtain actual costs of the product.

Other objects, advantages and novel features of the present. invention will be drawn from the following detailed description of preferred embodiments of the present invention with the attached drawings, in which:

### BRIEF DESCRIPTION OF THE DRAWINGS

FIG. 1 is a schematic diagram of an application environment including a system for integration of actual product costs in accordance with a preferred embodiment of the present invention;

FIG. 2 is essentially a block diagram of sub-modules comprised in a value-added cost integration module of a web server of the system for integration of actual product costs of FIG. 1;

FIG. 3 is essentially a block diagram of sub-modules comprised in a material cost integration module of a web server of the system for integration of actual product costs of FIG. 1;

FIG. 4 is a main flowchart for operating the system for integration of actual product costs in accordance with preferred embodiment of the present invention;

FIG. 5 is a flowchart for integrating the value-added costs of a product in accordance with a preferred embodiment of the present invention;

FIG. 6 is a flowchart of details of one step shown in FIG. 5, namely calculating the value-added costs of each product; and

FIG. 7 is a flowchart for integrating the material costs of a product in accordance with a preferred embodiment of the present invention.

### DETAILED DESCRIPTION OF PREFERRED EMBODIMENTS OF THE INVENTION

Reference will now be made to the drawings to describe the present invention in detail.

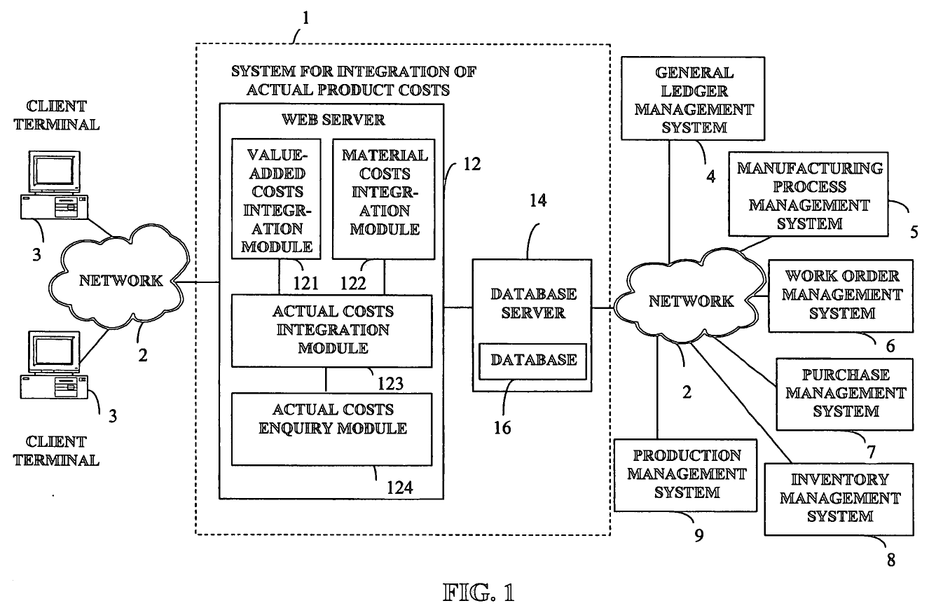

FIG. 1 is a schematic diagram of an application environment including a system for integration of actual product costs 1 (hereinafter simply referred to as the system 1) in accordance with a preferred embodiment of the present invention. The system 1 is connected to a plurality of client terminals 3, a general ledger management system 4, a manufacturing process management system 5, a work order management system 6, a purchase management system 7, an inventory management system 8 and a production management system 9 via a network 2. The system 1 comprises a web server 12, a database server 14, and a database 16. The system 1 uses a web-based solution, i.e. an application program of the system 1 runs on the web server 12. Using Internet access software installed in the client terminals 3, users of the system 1 such as cost management personnel and supervisors can log in the web server 12 via the network 2 with a www (world wide web) address. The users can then perform all required operations within the system 1 and obtain relevant data. The operations include value-added costs integration, material costs integration, and actual costs integration. The web server 12 comprises a value-added costs integration module 121, a material costs integration module 122, an actual costs integration module 123, and an actual costs enquiry module 124. The value-added costs integration module 121 calculates value-added costs of each product based on manufacturing expenses data and work time data on work orders. The material costs integration module 122 calculates material costs of each product based on purchase data, inventory data, and consumed material data. The actual costs integration module 123 calculates actual costs of each product by integrating the material costs and the value-added costs of the product. The actual product costs enquiry module 124 performs enquiry operations. That is, the actual product costs enquiry module 124 retrieves the actual costs, value-added costs, material costs and other relevant data of each product, and sends the data to a respective client terminal 3. The Internet access software is Internet Explorer from Microsoft Corp. or Navigator from Netscape Corp. The network 2 is the Internet or an intranet.

The web server 12 is connected to the database server 14, which contains the database 16. The database server 14 can exchange data with the general ledger management system 4, the manufacturing process management system 5, the work order management system 6, the purchase management system 7, the inventory management system 8 and the production management system 9 via the network 2. The database server 14 receives manufacturing expenses data from the general ledger management system 4, basic data of operation centers from the manufacturing process management system 5, work time data on work orders from the work order management system 6, purchase data from the purchase management system 7, inventory data from the inventory management system 8, and consumed material data from the production management system 9. The database 16 stores the manufacturing expenses data, purchase data, inventory data and consumed material data. The database 16 further stores cost variable definition data, operation center definition data, cost group data, an operation center variance list, an operation center expenses rate list, and so on. The database 16 further stores a material purchase costs list, a relevant inventory costs list, and an integrated product material costs list. The database 16 further stores an actual product costs list.

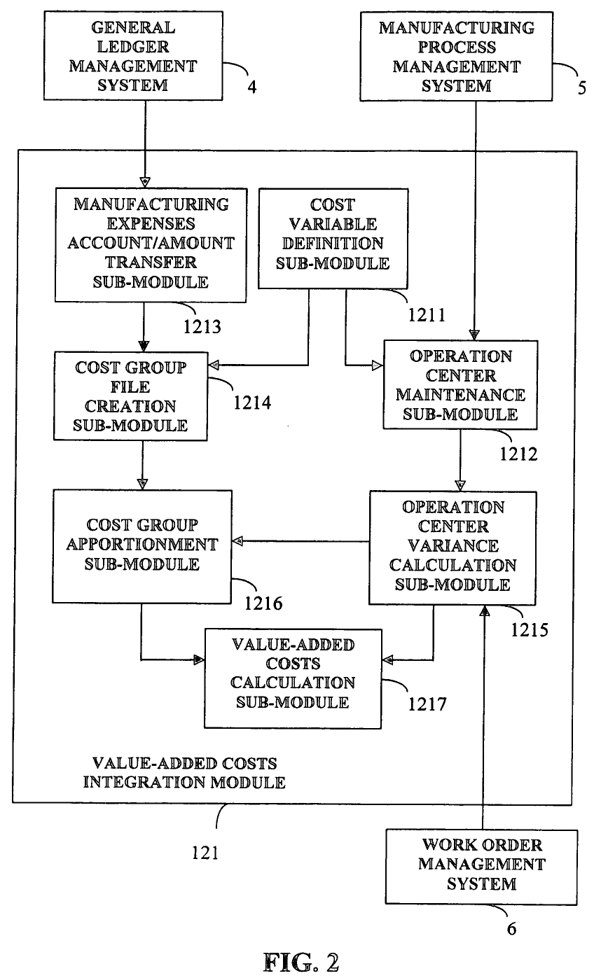

FIG. 2 is essentially a block diagram of sub-modules comprised in the value-added costs integration module 121 of the web server 12. The value-added costs integration module 121 comprises a cost variable definition sub-module 1211, an operation center maintenance sub-module 1212, a manufacturing expenses account/amount transfer sub-module 1213, a cost group file creation sub-module 1214, an operation center variance calculation sub-module 1215, a cost group apportionment sub-module 1216, and a value-added costs calculation sub-module 1217.

The cost variable definition sub-module 1211 is used for defining possible cost variables, cost variable codes and other relevant data when calculating product value-added costs. Cost variables are factors that affect product value-added costs, such as labor work time, machine work time, etc. In the preferred embodiment of the present invention, the cost variables can be an apportionment standard for apportioning costs of cost groups (i.e. cost categories) to operation centers (assembly lines, work stations, etc.), as well as an apportionment standard for apportioning operation center costs to product costs.

Based on operation center basic data obtained from the manufacturing process management system 5, the operation center maintenance sub-module 1212 performs operation center maintenance. That is, the operation center maintenance sub-module 1212 selects work centers in operation centers and specifies cost variables to be apportioned to product value-added costs. Each product is a finished product, a semi-finished product or a product manufactured according to a contract. An operation center may be an assembly line, a production station, etc. Each operation center serves as a basic unit for collection of production site manufacturing expenses data.

The manufacturing expenses account/amount transfer sub-module 1213 performs manufacturing expenses account/amount transfers. In a transfer, the database server 14 obtains manufacturing expenses information from the general ledger management system 4, calculates manufacturing expenses data in a current period, and saves the data in the database 16.

The cost group file creation sub-module 1214 divides a company's department or product groups into different cost groups according to different cost variables, defines manufacturing expenses accounts and cost variables in each cost group, and calculates the manufacturing expenses of each cost group by summing up values of all of the manufacturing expenses accounts based on the manufacturing expenses data.

The operation center variance calculation sub-module 1215 obtains work time data on work orders from the work order management system 6. That is, the operation center variance calculation sub-module 1215 keeps a record of each work center's work time on work orders and a quantity of output of each product for the current period of cost calculations, and calculates the sum of all the operation centers' cost variances and each product's cost variance for each operation center. Cost variance is hereinafter referred to simply as “variance.” The operation center total variance of each operation center is the total of product variances for each type of product for each work center contained in that operation center. Each product variance is the product's work time on work orders (such as labor work time and machine work time). The formula for calculating the product variance of each product in one operation center is:

V=WT/Q

where V stands for the product variance of the product in the operation center, WT stands for the total work time on work orders of the product in the operation center, and Q stands for the total manufactured quantity of the product.

The total work time on work orders of the product in the operation center is the total of work time on work orders in each work center contained in that operation center.

The cost group apportionment sub-module 1216 specifies a ratio of each cost group's manufacturing expenses apportioned to each operation center, i.e. an apportioned variance of each operation center, and generates cost group apportionment data that are stored in the database 16. Cost group apportionment data of a previous period's cost calculations can be obtained from the cost group apportionment sub-module 1216, and are used to define the cost group apportionment data of the current period. The apportioned expenses of each cost group's manufacturing expenses to be apportioned to corresponding operation centers can be determined by the sum of the operation center total variances corresponding to the cost group generated by the operation center variance calculation sub-module 1215.

The value-added costs calculation sub-module 1217 calculates each operation center's total costs by using the operation center total variance, each cost group's manufacturing costs corresponding to the operation center, and the operation center's apportioned variance. The value-added costs calculation sub-module 1217 further calculates each operation center's expenses rate and each operation center's value-added costs for a particular product, according to the operation center's total costs and the operation center's total variance. The formulas for calculating each operation center's total costs, expenses rate and value-added costs for a particular product are as follows: operation center total costs=ΣE_{M}*(V_{A}/V_{S})

where E_{M}*(V_{A}/V_{S}) is equal to the manufacturing expenses apportioned to the operation center, and where E_{M} stands for manufacturing expenses, V_{A} stands for the apportioned variance of the operation center in a cost group, and V_{S} stands for the sum of all the operation center total variances in the cost group;

R_{E}=C_{T}/V_{T}

where R_{E} stands for the operation center's expenses rate, C_{T} stands for the operation center's total costs, and V_{T} stands for the operation center's total variance; and

C=R_{E}*V_{P}

where C_{V} stands for the operation center's product costs for a particular product, R_{E} stands for the operation center's expenses rate, and V_{P} stands for the product variance of the operation center.

The value-added costs of a particular product is calculated according to the following formula:

Value-added costs of a particular product=Σoperation center product costs for all the operation centers.

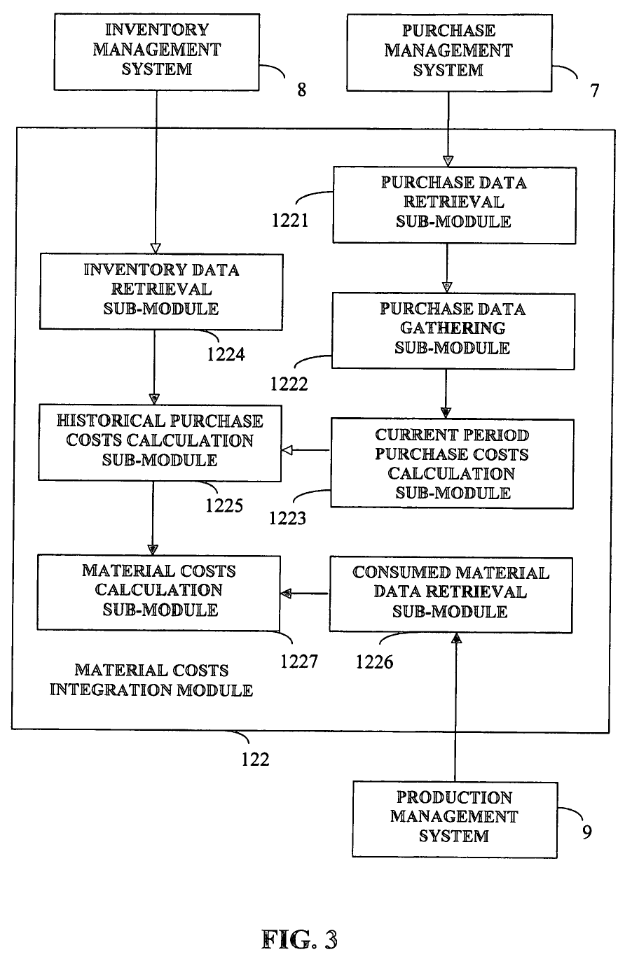

FIG. 3 is essentially a block diagram of sub-modules comprised in the material costs integration module 122 of the web server 12. The material costs integration module 122 comprises a purchase data retrieval sub-module 1221, a purchase data gathering sub-module 1222, a current period purchase costs calculation sub-module 1223, an inventory data retrieval sub-module 1224, a historical purchase costs calculation sub-module 1225, a consumed material data retrieval sub-module 1226, and a material costs calculation sub-module 1227.

The purchase data retrieval sub-module 1221 generates a purchase data retrieval request based on a fiscal year or other accounting period information input by a cost manager via a user interface provided by a respective client terminal 3, and sends the request to the database server 14. Upon receiving the request, the database server 14 accesses the purchase management system 7 to obtain current period purchase data, and saves the data as purchase data in the database 16. The purchase data comprise purchase date, material number, material name, purchase quantity, purchase unit price, purchase expenses, and so on.

The purchase data gathering sub-module 1222 gathers the current period purchase data of each material to obtain a total purchase quantity, a total purchase value and total purchase expenses of each material.

The current period purchase costs calculation sub-module 1223 calculates purchase expenses apportioned to each unit of each material based on the total purchase expenses of the material and the purchase quantity of the material. The current period purchase costs calculation sub-module 1223 further calculates a current period's purchase costs of a unit of each material based on the purchase expenses apportioned to each unit of each material, the total purchase value and the total purchase quantity of the material gathered by the purchase data gathering sub-module 1222. The formula for calculating the purchase expenses apportioned to each unit of each material is:

E_{UP}=E_{TP}/Q_{TP}

where E_{UP} stands for the purchase expenses apportioned to each unit of the material, E_{TP} stands for the total purchase expenses of the material, and Q_{TP} stands for the purchase quantity of the material.

The formula for calculating current period purchase costs of a unit of each material is:

C_{UP}=E_{UP}+(E_{TV}/Q_{TP})

where C_{UP} stands for current period purchase costs of a unit of the material, E_{UP} stands for the purchase expenses apportioned to each unit of the material, E_{TV} stands for the total purchase value of the material, and Q_{TP} stands for the total purchase quantity of the material.

The current period purchase costs calculation sub-module 1223 stores the purchase expenses apportioned to each unit of each material and current period purchase costs of a unit of each material in a current period purchase costs list. The current period purchase costs list further contains information on material number, material name, total purchase expenses, total purchase quantity, unit price, total purchase value, and so on.

The inventory data retrieval sub-module 1224 generates an inventory data retrieval request based on the fiscal year or other accounting period input by the cost manager, and sends the request to the database server 14. Upon receiving the request, the database server 14 accesses the inventory management system 8 to obtain current period inventory data and initial inventory data, and stores the data in the database 16.

The historical purchase costs calculation sub-module 1225 calculates the historical purchase costs of a unit of each material based on the initial inventory data and the current period purchase costs list. The initial inventory data comprise initial inventory quantity and initial inventory value. The result of the calculation is saved in a historical purchase costs list. The formula for calculating the historical purchase costs of a unit of each material is:

C_{UHP}=(V_{II}+Q_{P}*C_{UP})/(Q_{P}+Q_{IO})

where C_{UHP} stands for the historical purchase costs of a unit of the material, V_{II} stands for the initial inventory value, Q_{P} stands for the current period purchase quantity, C_{UP} stands for the current period purchase costs of a unit of the material, and Q_{IO} stands for the initial inventory quantity.

The consumed material data retrieval sub-module 1226 generates a consumed material data retrieval request according to the fiscal year or other accounting period input by the cost manager, and sends the request to the database server 14. Upon receiving the request, the database server 14 accesses the production management system 9 to obtain current period consumed material data, and stores the data in the database 16. The consumed material data comprises product name, product number, current period produced quantity, and all consumed materials' numbers, names and quantities.

The material costs calculation sub-module 1227 calculates costs of each material consumed in a particular product based on the quantity of the consumed material, historical purchase costs of a unit of the material and the produced quantity of the product. The material costs calculation sub-module 1227 further calculates the material costs of the product based on the costs of each material consumed in the product. The material cost integration sub-module 1227 sums up the costs of all materials consumed in the product to obtain material costs of the product, and saves the result in a material costs integration list. The formula for calculating the costs of each material consumed in the product is:

C_{CM}=Q_{WM}*C_{UHP}/Q

where C_{CM} stands for the costs of a particular material consumed in the product, Q_{WM} stands for the quantity of the consumed material, C_{UHP} stands for the historical purchase costs of a unit of the material, and Q stands for the produced quantity of the product.

The formula for calculating the material costs of the product is:

C_{M}=ΣC_{CM}

where C_{M} stands for the material costs of the product, and C_{CM} stands for the costs of each material consumed in the product.

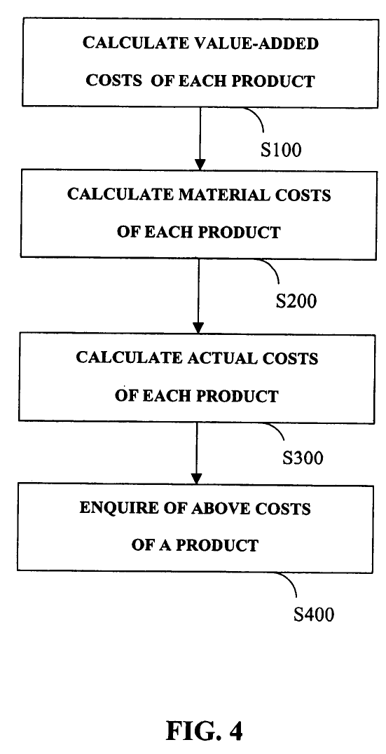

FIG. 4 is a main flowchart for operating the system 1 in accordance with the preferred embodiment of the present invention. In step S100, the value-added costs integration module 121 calculates the value-added costs of a particular product based on the manufacturing expenses of each cost group, the apportioned variance of each operation center, the operation center total variance of each operation center, and the product variance of the product. In step S200, the material costs integration module 122 calculates the material costs of the product based on the produced quantity of the product, total consumed materials quantities of the product, and the historical purchase costs of each material. In step S300, the actual costs integration module 123 sums up the value-added costs of the product and the material costs of the product to obtain the actual costs of the product, and generates an actual product costs list. The actual product costs list comprises information on each product's name, number, actual costs, value-added costs, material costs, value-added costs in each operation center, and costs of each consumed material. In step S400, the cost management personnel enquire of the actual costs, value-added costs and material costs of a product via the actual costs enquiry module 124.

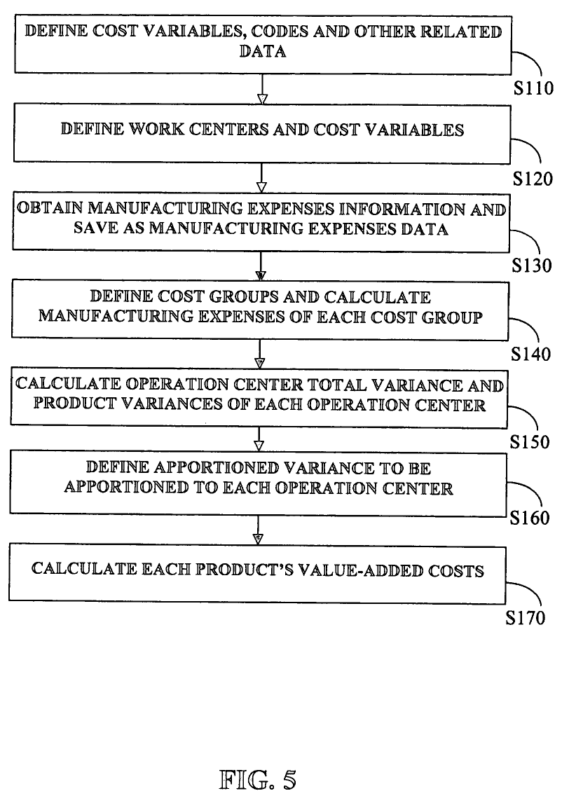

FIG. 5 is a flowchart for integrating the value-added costs of a product in accordance with a preferred embodiment of the present invention. In step S110, the cost management personnel perform cost variable maintenance by using the cost variable definition sub-module 1211. That is, said personnel define cost variables, codes and other related data which are likely to be used during product cost calculations to generate the cost variable definition data. In step S120, the cost management personnel perform operation maintenance by using the operation center maintenance sub-module 1212. That is, said personnel obtain operation center basic data from the manufacturing process management system 5. Said personnel define work centers in each operation center and determine cost variables of each product's costs, based on the operation center basic data and the cost variable definition data. The operation center definition data are thereby generated. In step S130, the manufacturing expenses account/amount transfer sub-module 1213 obtains manufacturing expenses information from the general ledger management system 4, and saves the information in the database 16 as the manufacturing expenses data. In step S140, the cost group file creation sub-module 1214 creates a cost group file. That is, the cost group file creation sub-module 1214 defines the cost groups, defines manufacturing expenses accounts and cost variables in each cost group, calculates the manufacturing expenses of each cost group, and thereby generates the cost group data. In step S150, the operation center variance calculation sub-module 1215 sums up all the work time on work orders of each work center in each operation center based on work time data on work orders of the current period obtained from the work order management system 6 and definitions of the operation center definition data, calculates the operation center total variance and product variances of each operation center, and thereby generates the operation center variance list. In step S160, the cost group apportionment sub-module 1216 defines the apportioned variance to be apportioned to each operation center from the cost group's manufacturing expenses. The cost group apportionment data are thereby generated. In step S170, the value-added costs calculation sub-module 1217 calculates the value-added costs of each product based on the manufacturing expenses of each cost group, the apportioned variance of each operation center, the operation center total variance of each operation center and the product variance of the product.

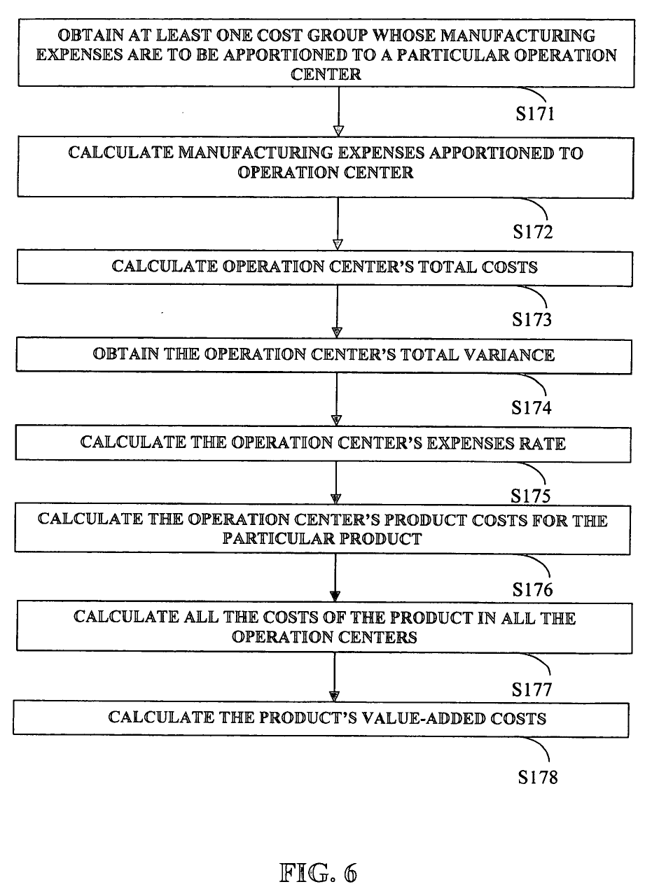

FIG. 6 is a flowchart of details of step S170 of FIG. 5, namely calculating the value-added costs of each product. In step S171, using an operation center name as an enquiry keyword, the value-added costs calculation sub-module 1217 searches the cost group apportionment data to obtain data for at least one cost group whose manufacturing expenses are to be apportioned to the particular operation center. In step S172, the value-added costs calculation sub-module 1217 calculates manufacturing expenses apportioned to the operation center by using the following formula:

A_{C}=C_{G}*(V_{A}/TV_{A})

where A_{C} stands for the apportioned costs of the operation center, C_{G} stands for the costs of a cost group, V_{A} stands for the apportioned variance of the operation center, and TV_{A} stands for the total apportioned variances of all the operation centers.

In step S173, the product costs of the operation center is calculated by summing up all the manufacturing expenses apportioned to the operation center; that is, by using the following formula:

operation center product costs=ΣE_{M}*(V_{A}/V_{S})

where E_{M}*(V_{A}/V_{S}) is equal to the manufacturing expenses apportioned to the operation center,

and where E_{M} stands for manufacturing expenses, V_{A} stands for the apportioned variance of the operation center in a cost group, and V_{S} stands for the sum of all the operation center total variances in the cost group.

In step S174, the operation center total variance is obtained by searching the operation center variance list, using the operation center's name as an enquiry keyword. In step S175, the operation center's expenses rate is calculated by using the following formula:

R_{E}=C_{T}/V_{T}

where R_{E} stands for the operation center's expenses rate, C_{T} stands for the total costs of the operation center, and V_{T} stands for the operation center's total variance.

In step S176, the operation center product costs for the product is calculated by using the following formula:

C_{V}=R_{E}*V_{P}

where C_{V} stands for the operation center product costs for the product, R_{E} stands for the expenses rate of the operation center, and V_{P} stands for the product variance of the operation center which is obtained by enquiry of the operation center variance list 165.

Steps S171 through S175 are repeated so that in step S177, all the product costs of the product in all the operation centers are calculated. In step S178, all these product costs are summed up, so that the value-added costs of the product is obtained.

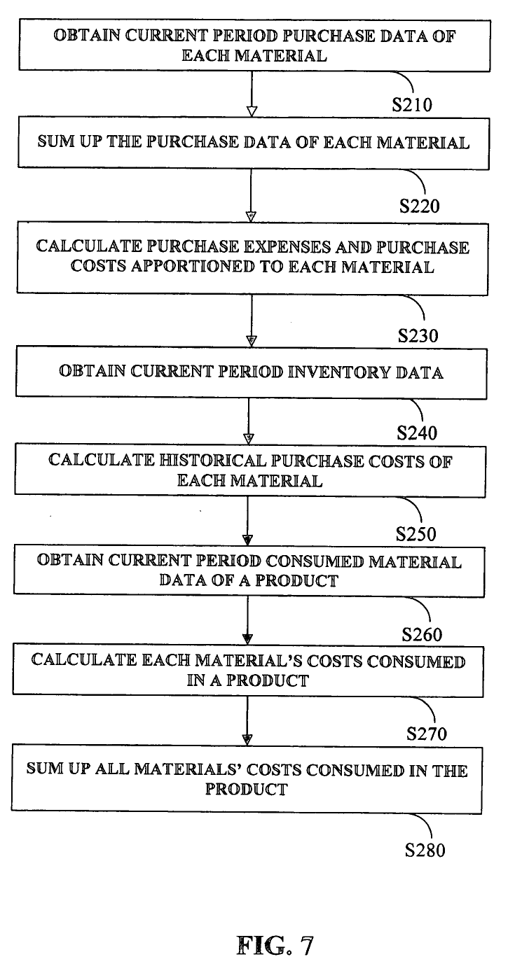

FIG. 7 is a flowchart for integrating the material costs of a product in accordance with a preferred embodiment of the present invention. In step S210, using an accounting period as an enquiry keyword, the material costs calculation sub-module 1227 searches the purchase management system 7 via the database server 14 to obtain the current period purchase data of each material. In step S220, the purchase data gathering sub-module 1222 gathers the current period purchase data of each material to obtain a current period purchase quantity, a total purchase value and total purchase expenses of the material. In step S230, the current period purchase costs calculation sub-module 1223 calculates purchase expenses apportioned to each unit of each material based on the total purchase expenses of the material and the purchase quantity of the material. The current period purchase costs calculation sub-module 1223 further calculates a current period's purchase costs of a unit of each material based on the purchase expenses apportioned to each unit of each material, the total purchase value and total purchase quantity of the material gathered by the purchase data gathering sub-module 1222. The formula for calculating the current period purchase expenses of each unit of each material is:

E_{UP}=E_{TP}/Q_{TP}

where E_{UP} stands for the current period purchase expenses of each unit of the material, E_{TP} stands for the total purchase expenses of the material, and Q_{TP} stands for the purchase quantity of the material.

The formula for calculating current period purchase costs of a unit of each material is:

C_{UP}=E_{UP}+(E_{TV}/Q_{TP})

where C_{UP} stands for the current period purchase costs of a unit of the material, E_{UP} stands for the current period purchase expenses of each unit of the material, E_{TV} stands for the total purchase value, and Q_{TP} stands for total purchase quantity.

In step S240, using an accounting period as an enquiry keyword, the inventory data retrieval sub-module 1224 searches the inventory management system 8 via the database server 14 to obtain the current period inventory data. In step S250, the historical purchase costs calculation sub-module 1225 calculates the historical purchase costs of a unit of each material based on the initial inventory data and the current period purchase costs list. The result of the calculation is saved in a historical purchase costs list. The formula for calculating the historical purchase costs of a unit of each material is:

C_{UHP}=(V_{II}+Q_{P}*C_{UP})/(Q_{P}+Q_{IO})

where C_{UHP} stands for the historical purchase costs of a unit of the material, V_{II} stands for the initial inventory value, Q_{P} stands for the current period purchase quantity, C_{UP} stands for the current period purchase costs of a unit of the material, and Q_{IO} stands for the initial inventory quantity.

In step S260, using a product name and the accounting period as the enquiry keywords, the consumed material data retrieval sub-module 1226 searches the production management system 9 via the database server 14 to obtain the current period consumed material data of a product. In step S270, the material costs calculation sub-module 1227 calculates costs of each material consumed in the product based on the quantity of the consumed material, historical purchase costs of a unit of the material and the produced quantity of the product. The material costs calculation sub-module 1227 further calculates the material costs of the product based on the costs of each material consumed in the product. The formula for calculating the costs of each material consumed in the product is:

C_{CM}=Q_{WM}*C_{UHP}/Q

where C_{CM} stands for the costs of a particular material consumed in the product, Q_{WM} stands for the quantity of the consumed material, C_{UHP} stands for the historical purchase costs of a unit of the material, and Q stands for the produced quantity of the product.

In step S280, the material cost integration sub-module 1227 sums up the costs of all materials consumed in the product to obtain material costs of the product, and saves the result in a material costs integration list. The formula for calculating the material costs of the product is:

C_{M}=ΣC_{CM}

where C_{M} stands for the material costs of the product, and C_{CM} stands for the costs of each material consumed in the product.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for integration of actual product costs for calculating actual costs of a product, the system comprising a web server and a database server, wherein:
the database server comprises a database for storing cost variable definition data, operation center definition data, manufacturing expenses data, purchase data, inventory data and consumed material data, said cost variable definition data comprising cost variance (hereinafter “variance”) related data including a cost variable code field, a cost variable name field, a cost variable unit field and other fields, said operation center definition data comprising data on cost variables and work centers of each of operation centers, said manufacturing expenses data comprising expenses of each of manufacturing expenses accounts, said purchase data comprising purchase date, material number, material name, purchase quantity, purchase unit price, purchase expenses, said inventory data comprising current period inventory data and initial inventory data, said consumed material data comprising product name, product number, current period produced quantity, and all consumed materials' numbers, names and quantities; and
the web server comprises:
a value-added costs integration module for calculating value-added costs of a product, the value-added costs integration module comprising:
a cost group file creation sub-module for defining cost groups, manufacturing expenses accounts and cost variables in each cost group, and for calculating the manufacturing expenses of each cost group based on the manufacturing expenses data and the cost variable definition data;
an operation center variance calculation sub-module for calculating the sum of all the operation centers' variances and each product's variance for each operation center, based on the operation center definition data and the work time data on work orders;
a cost group apportionment sub-module for specifying a ratio of each cost group's manufacturing expenses apportioned to each operation center; and
a value-added costs calculation sub-module for calculating each operation center's total costs, each cost group's manufacturing costs corresponding to the operation center, and the operation center's apportioned variance;
a material costs integration module for calculating material costs of a product, the material costs integration module comprising:
a current period purchase costs calculation sub-module for calculating purchase expenses apportioned to each of units of a material and current period purchase costs of a unit of the material based on purchase data of the material;
a historical purchase costs calculation sub-module for calculating historical purchase costs of a unit of the material based on the inventory data and the current period purchase costs;
a material costs calculation sub-module for calculating costs of each material consumed in a product based on the quantity of the consumed material, historical purchase costs of a unit of the material and the produced quantity of the product, and for calculating the material costs of the product based on the costs of each material consumed in the product; and
an actual costs integration module for calculating actual costs of the product by summing up the value-added costs and the material costs of the product.

2. The system for integration of actual product costs as claimed in claim 1, wherein the value-added costs integration module further comprises a manufacturing expenses account/amount transfer sub-module which obtains manufacturing expenses information, calculates manufacturing expenses data, and stores the manufacturing expenses data in a database.

3. The system for integration of actual product costs as claimed in claim 1, wherein the value-added product costs integration module further comprises an operation center maintenance sub-module for selecting work centers in operation centers and specifying cost variables to be apportioned to product costs.

4. The system for integration of actual product costs as claimed in claim 1, wherein the cost group file creation sub-module is used for summing up values of all of the manufacturing expenses accounts based on the manufacturing expenses data.

5. The system for integration of actual product costs as claimed in claim 1, wherein the operation center variance calculation sub-module sums up all work time on work orders of each work center of each operation center, for calculating an operation center total variance and product variances of each operation center.

6. The system for integration of actual product costs as claimed in claim 1, wherein the value-added costs calculation sub-module calculates each operation center's total costs based on the cost group apportionment variance of the operation center, and calculates each operation center's expenses rate and each operation center's product costs for each product.

7. The system for integration of actual product costs as claimed in claim 1, wherein the material costs integration module further comprises a purchase data gathering sub-module for gathering current period purchase data of the material to obtain a total purchase quantity, a total purchase value and total purchase expenses of the material.

8. The system for integration of actual product costs as claimed in claim 1, wherein the material costs integration module further comprises a purchase data retrieval sub-module for retrieving purchase data of the material.

9. The system for integration of actual product costs as claimed in claim 1, wherein the material costs integration module further comprises an inventory data retrieval sub-module for retrieving the inventory data of materials.

10. The system for integration of actual product costs as claimed in claim 1, wherein the material costs integration module further comprises a consumed material data retrieval sub-module for retrieving the consumed material data of the product.

11. A computer-enabled method for integration of actual product costs in order to calculate actual product costs of a product, the method comprising the steps of:
(a) calculating value-added costs of a product, comprising:
(a1) defining cost variables, codes and other related data for generating cost variable definition data;
(a2) defining work centers in each of operation centers and determining cost variables of each product in order to generate operation center definition data;
(a3) obtaining manufacturing expenses information and saving the information as manufacturing expenses data;
(a4) defining cost groups, and manufacturing expenses accounts and cost variables in each cost group based on the cost variable definition data and manufacturing expenses definition data, and calculating manufacturing expenses of each cost group;
(a5) obtaining work time data on work orders, summing up all the work time on work orders of each work center in each operation center, and calculating an operation center total variance and product variances of each operation center;
(a6) defining an apportioned variance to be apportioned to each operation center from the cost group's manufacturing expenses; and
(a7) calculating the value-added costs of each product based on the manufacturing expenses of each cost group, the apportioned variance of each operation center, the operation center total variance of each operation center, and a product variance of that product;
(b) calculating material costs of a product, comprising:
(b1) obtaining purchase data and saving the data in the database;
(b2) calculating current period purchase expenses apportioned to each of units of each material and current period costs of each unit of each material;
(b3) obtaining inventory data and saving the data in the database;
(b4) calculating historical purchase costs of each unit of each material;
(b5) obtaining consumed material data of a product and saving the data in the database;
(b6) calculating costs of each material consumed in the product; and
(b7) summing up costs of all materials consumed in the product to obtain material costs of the product; and
(c) adding the value-added costs and the material costs of a product to obtain actual costs of the product.

12. The method for integration of actual product costs as claimed in claim 11, wherein step (a2) further comprises the step of selecting work centers in each operation center.

13. The method for integration of actual product costs as claimed in claim 11, wherein in step (a4), the manufacturing expenses of each cost group is obtained by adding up the values of manufacturing expenses accounts of each cost group.

14. The method for integration of actual product costs as claimed in claim 11, wherein in step (a5), the work time data on work orders comprises work time on work orders and an output quantity of each product in each work center.

15. The method for integration of actual product costs as claimed in claim 14, wherein in step (a5), each product's total work time is obtained by adding up all the work times on work orders of the product from all the operation centers.

16. The method for integration of actual product costs as claimed in claim 15, wherein in step (a5), each product's work time in each operation center is obtained by adding up the product's work time on work orders of all the work centers of the operation center.

17. The method for integration of actual product costs as claimed in claim 11, wherein step (a7) further comprises the steps of:
calculating manufacturing expenses apportioned to each operation center;
calculating each operation center's expenses rate based on the total costs of the operation center and the operation center's total variance;
calculating the operation center product costs for a particular product in each operation center, based on the expenses rate of the operation center and the product variance of the operation center; and
adding up the operation center product costs for the product in all the operation centers, to obtain the value-added costs for the product.

18. The method for integration of value-added product cost as claimed in claim 11, wherein step (b1) further comprises the step of gathering current period purchase data of a particular material to obtain a current period purchase quantity, a total purchase value and total purchase expenses of the material.

19. A system for integration of actual product costs, the system comprising a web server, which comprises:
a value-added costs integration module for calculating value-added costs of a product;
a material costs integration module for calculating material costs of the product; and
an actual costs integration module for calculating actual costs of said product by summing up the value-added costs and the material costs of said product.

20. The system for integration of actual product costs as claimed in claim 19, wherein the value-added costs integration module further comprises:
a manufacturing expenses account/amount transfer sub-module for obtaining manufacturing expenses information, calculating manufacturing expenses data, and storing the manufacturing expenses data in a database;
an operation center maintenance sub-module for selecting work centers in operation centers and specifying cost variables to be apportioned to product costs;
a cost group file creation sub-module for defining cost groups, manufacturing expenses accounts and cost variables in each cost group, and for calculating the manufacturing expenses of each cost group based on the manufacturing expenses data and the cost variable definition data;
an operation center variance calculation sub-module for calculating the sum of all the operation centers' variances and each product's variance for each operation center, based on the operation center definition data and the work time data on work orders;
a cost group apportionment sub-module for specifying a ratio of each cost group's manufacturing expenses apportioned to each operation center; and
a value-added costs calculation sub-module for calculating each operation center's total costs, each cost group's manufacturing costs corresponding to the operation center, and the operation center's apportioned variance.

21. The system for integration of actual product costs as claimed in claim 19, wherein the material costs integration module further comprises:
a current period purchase costs calculation sub-module for calculating purchase expenses apportioned to each of units of a material and current period purchase costs of a unit of the material based on purchase data of the material;
a historical purchase costs calculation sub-module for calculating historical purchase costs of a unit of the material based on the inventory data and the current period purchase costs; and
a material costs calculation sub-module for calculating costs of each material consumed in a product and the material costs of the product based on the quantity of the consumed material, historical purchase costs of a unit of the material and the produced quantity of the product, and for calculating the material costs of the product based on the costs of each material consumed in the product.

22. A computer-enabled method for integration of actual product costs, the method comprising the steps of:
(a) calculating value-added costs of a product;
(b) calculating material costs of the product; and
(c) adding the value-added costs and the material costs of the product to obtain actual costs of the product.

23. The method for integration of actual product costs as claimed in claim 22, wherein step (a) comprises the steps of:
(a1) defining cost variables, codes and other related data for generating cost variable definition data;
(a2) defining work centers in each of operation centers and determining cost variables of each product in order to generate operation center definition data;
(a3) obtaining manufacturing expenses information and saving the information as manufacturing expenses data;
(a4) defining cost groups, and manufacturing expenses accounts and cost variables in each cost group based on the cost variable definition data and manufacturing expenses definition data, and calculating manufacturing expenses of each cost group;
(a5) obtaining work time data on work orders, summing up all the work time on work orders of each work center in each operation center, and calculating an operation center total variance and product variances of each operation center;
(a6) defining an apportioned variance to be apportioned to each operation center from the cost group's manufacturing expenses; and
(a7) calculating the value-added costs of each product based on the manufacturing expenses of each cost group, the apportioned variance of each operation center, the operation center total variance of each operation center, and a product variance of that product.

24. The method for integration of actual product costs as claimed in claim 22, wherein step (b) comprises the steps of:
(b1) obtaining purchase data and saving the data in the database;
(b2) calculating current period purchase expenses apportioned to each unit of each material and current period costs of each unit of each material;
(b3) obtaining inventory data and saving the data in the database;
(b4) calculating historical purchase costs of each unit of each material;
(b5) obtaining consumed material data of a product and saving the data in the database;
(b6) calculating costs of each material consumed in the product; and
(b7) summing up costs of all materials consumed in the product to obtain material costs of the product.
